(19) United States
(12) Patent Application Publication
(10) Pub. No.: US 2006/0268331 A1
(43) Pub. Date: Nov. 30, 2006

(54) PRINTING SYSTEM, IMAGE FORMING APPARATUS, AND COMPUTER PRODUCT

(76) Inventor: Shigeki Fukunishi, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/419,389

(22) Filed: May 19, 2006

(30) Foreign Application Priority Data
May 27, 2005 (JP) 2005-155919

(51) Int. Cl. G06F 3/12

(52) U.S. Cl. 358/1.15

(57) ABSTRACT

An authentication processing unit performs an authentication process of determining whether printing of a printing job is allowed. A job control unit executes the printing of the printing job when an authentication is obtained with the authentication processing unit determining that the printing of the printing job is allowed. A faint-background generating unit appends, upon the job control unit executing the printing of the printing job, information on the authentication to the printing job as faint-background data including a copy-control pattern that appears on a copy of a document.

### CROSS-REFERENCE TO RELATED APPLICATIONS

The present document incorporates by reference the entire contents of Japanese priority document, 2005-155919 filed in Japan on May 27, 2005.

### BACKGROUND OF THE INVENTION

1. Field of the Invention

The present invention generally relates to a technology for appending faint-background data in an image to enhance security of a document.

2. Description of the Related Art

There are image forming apparatuses that append faint-background data to printing data of an important document and then print faint-background-appended printing data to allow distinguishing between an original document from a copy of the document when copying an important document including a confidential document, such as a prescription, and a document having market value, such as a currency note. A conventional technology for the faint-background printing is disclosed in, for example, Japanese Patent Application Laid-Open No. 2005-006169, Japanese Patent Application Laid-Open No. 2001-324898, and Japanese Patent Application Laid-Open No. 2002-366693.

The faint-background data is generated by combining a copy-remain pattern that is optically readable after copying and a copy-delete pattern that is optically unreadable after copying. When a document including the faint-background data is copied on a copy medium, such as a paper, the copy-remain pattern becomes visible on the paper, so that it becomes obvious that it is a copy and not the original.

In some cases there is a need to identify a leakage source, which is an apparatus or a person from where a document has leaked, of a printed material than to distinguish whether a printed material is a copy or an original. For example, if an unexamined patent application or an undisclosed product-proposing document has leaked, it is important to identify the leakage source than to distinguish whether it is a copy or an original because the document has leaked anyway. Some conventional techniques disclose including a logon-user name, of a personal computer (PC) used for outputting the document, in the copy-remain pattern. According to those techniques, when such a document is printed, the logon-user name becomes visible on the printed material, so that the leakage source of printed material can be easily identified.

However, it is not very difficult to change a logon-user name of the PC, so that the technique of including the logon-user name in the copy-remain pattern is not that reliable. A person having the right of an administrator of the PC can easily change the logon-user name of the PC, or a person having the right of an administrator of a network can easily change logon-user names of PCs on the network.

### SUMMARY OF THE INVENTION

It is an object of the present invention to at least partially solve the problems in the conventional technology.

A printing system according to one aspect of the present invention includes an information processing apparatus that processes various types of data; and a printing apparatus connected to the information processing apparatus via a network. The information processing apparatus includes an input processing unit that receives information required to obtain an authentication from the printing apparatus; a faint-background generating unit that appends a part of the received information to a printing job as faint-background data including a copy-control pattern that appears on a copy of a document; and a job transferring unit that transfers the printing job to the printing apparatus. The printing apparatus includes a job control unit that receives the printing job including the faint-background data from the information processing apparatus; an authentication processing unit that performs an authentication process of determining whether printing of the received printing job is allowed. The job control unit executes the printing of the received printing job when an authentication is obtained with the authentication processing unit determining that the printing of the printing job is allowed.

A printing system according to another aspect of the present invention includes an authentication processing unit that performs an authentication process of determining whether printing of a printing job is allowed; a job control unit that executes the printing of the printing job when an authentication is obtained with the authentication processing unit determining that the printing of the printing job is allowed; and a faint-background generating unit that appends, upon the job control unit executing the printing of the printing job, information on the authentication to the printing job as faint-background data including a copy-control pattern that appears on a copy of a document.

A computer-readable recording medium according to still another aspect of the present invention stores a computer for performing a printing process. The computer program causes a computer to execute performing an authentication process of determining whether printing of a printing job is allowed; executing the printing of the printing job when an authentication is obtained with the printing of the printing job determined to be allowed; and appending, when the printing of the printing job is executed, information on the authentication to the printing job as faint-background data including a copy-control pattern that appears on a copy of a document.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining a printing system including a printer according to a first embodiment of the present invention;

FIG. 2 is a block diagram for explaining a hardware structure of a computer terminal shown in FIG. 1;

FIG. 3 is a block diagram for explaining a software structure of the computer terminal;

FIG. 4 is a sequence diagram for explaining a processing sequence of controlling software shown in Fig. 3;

FIG. 5 is a flowchart for explaining a process performed by a job creating unit shown in FIG. 4;

FIG. 6 is a block diagram for explaining a hardware structure of a printer shown in FIG. 1;

FIG. 7 is a table of user information in hard disk device shown in FIG. 6;

FIG. 8 is a block diagram for explaining a software structure of the printer;

FIG. 9 is a sequence diagram for explaining a processing sequence of controlling software shown in FIG. 8;

FIG. 10 is a flowchart for explaining a process performed by a job control unit shown in FIG. 9;

FIG. 11 is a flowchart for explaining a process performed by an authentication processing unit shown in FIG. 9;

FIG. 12 is a block diagram for explaining another software structure of the computer terminal;

FIG. 13 is a sequence diagram for explaining a processing sequence of controlling software shown in FIG. 12;

FIG. 14 is a flowchart for explaining a process performed by a job creating unit shown in FIG. 13;

FIG. 15 is a block diagram for explaining another software structure of the printer;

FIG. 16 is a sequence diagram for explaining a processing sequence of controlling software shown in FIG. 15;

FIG. 17 is a flowchart for explaining a process performed by a job control unit shown in FIG. 16; and

FIG. 18 is a flowchart for explaining a process performed by a faint-background generating unit shown in FIG. 16.

### DETAILED DESCRIPTION OF THE PREFERRED EMBODIMENTS

Exemplary embodiments of the present invention are explained below in detail with reference to the accompanying drawings.

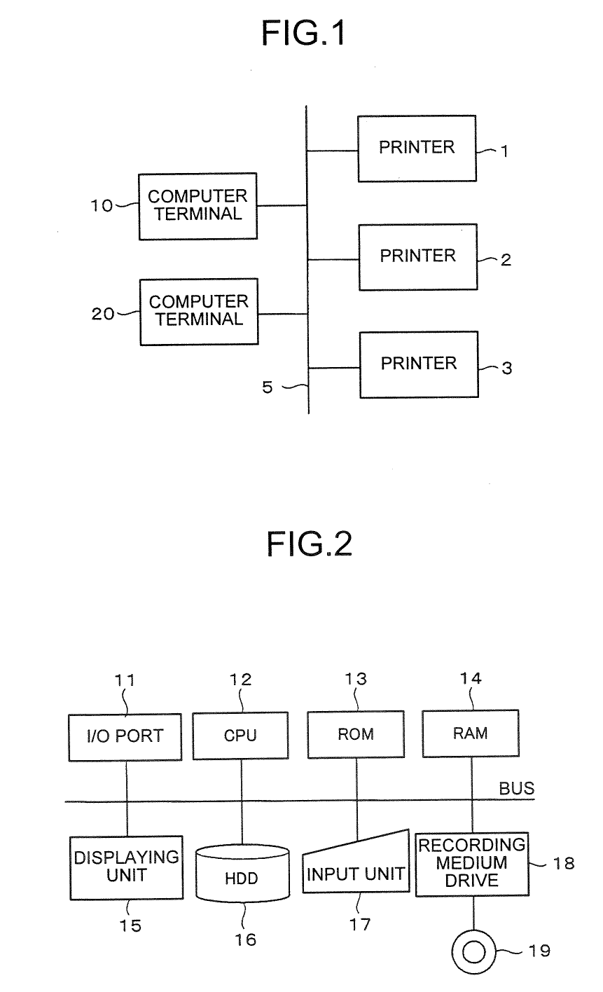

FIG. 1 is a schematic for explaining a printing system including a printer according to a first embodiment of the present invention.

The printing system according to the first embodiment includes computer terminals 10 and 20, printers 1 to 3, and a network 5. The computer terminals 10 and 20 are capable of connecting and communicating to the printers 1 to 3 via the network 5 and the network 5 is, for example, a local area network (LAN). Each of the computer terminals 10 and 20 selects any one of the printers 1 to 3 to transfer a printing job and print the printing job by using a printer driver in an application of the computer terminal 10 and 20.

The computer terminals 10 and 20 are generally information processing apparatuses (host apparatuses) such as a personal computer (PC), workstation, a client computer, or a print server. In a print server system, the client computer can be a web client, such as a web server or a web browser, of the print server (printing service).

The printers 1 to 3 are image forming apparatuses for printing a visible image on a paper by using a print data of the printing job transferred from the computer terminal 10 or 20. The image forming apparatus can be an apparatus having only a printing function such as a laser printer, a light emitting diode (LED) printer, or an ink jet printer. Alternately, the image forming apparatus can be an apparatus having not only the printing function but also a copying function, a print server function or the like, such as a digital copying machine, a digital integrated machine, or a facsimile apparatus.

FIG. 2 is a block diagram for explaining a hardware structure of the computer terminal 10. As the hardware structure of the computer terminal 20 is the same as the computer terminal 10, detail explanations of the computer terminal 20 will be omitted. The computer terminal 10 includes an input/output port (I/O port) 11, a central processing unit (CPU) 12, a read only memory (ROM) 13, a random access memory (RAM) 14, a displaying unit 15, a hard disk device (HDD) 16, an inputting unit 17, and a recording medium drive 18.

The I/O port 11 is a communication tool for relaying a communication between the computer terminal 10 and the printers 1 to 3 via the network 5. The CPU 12 centrally controls the computer terminal 10. The ROM 13 stores therein predetermined computer programs to be executed by the CPU 12. The RAM 14 is a readable and writeable memory to extract therein the predetermined computer programs, to be executed by the CPU 12, and be used as a work-area for various processing.

The displaying unit 15 can be a cathode-lay tube (CRT) display or a liquid crystal display (LCD) and displays various data or screens necessary for a printing operation. The HDD 16 is a high capacity memory and stores therein computer programs and various data including a copy-remain pattern and a copy-delete pattern. The inputting unit 17 can be a keyboard and/or a pointing device, such as a mouse, and is used by a user for inputting various data and/or commands including necessary information to perform authentication in any one printer to be used by the user.

The recording medium drive 18 is a recording and replaying unit that records data to and replays data from a recording medium 19. The recording medium 19 is a removable and computer-accessible device such as a magneto-optical (MO) disc, a compact disc-recordable (CD-R), a compact disc-rewritable (CD-RW), a digital versatile disc-recordable (DVD-R), a digital versatile disc-rewritable (DVD-RW), or a DVD-RAM and stores therein a control program (control software) to control printing. Alternately, the recording medium 19 can be built-in the body of the computer terminal 10.

When the user inputs a command from the inputting unit 17, the CPU 12 retrieves the control program from the recording medium 19 through the recording medium drive 18 and installs the control program into the HDD 16.

Then, when the computer terminal 10 is booted, the CPU 12 retrieves various computer programs, such as an operating system (OS), an application (application software), or a user interface, installed in the HDD 16 by using a boot loader (boot program) in the ROM 13 and installs the computer programs onto the RAM 14 to execute the computer programs. By performing the above process, it becomes possible to realize various functions corresponding to a faint-background generating unit according to the present invention.

The CPU 12 executes processing by using the control programs (control software); however, it is assumed here that the computer programs execute the processing. As the software structure and a printing processing of the computer terminal 20 is the same as the computer terminal 10, detail explanations of the computer terminal 20 will be omitted.

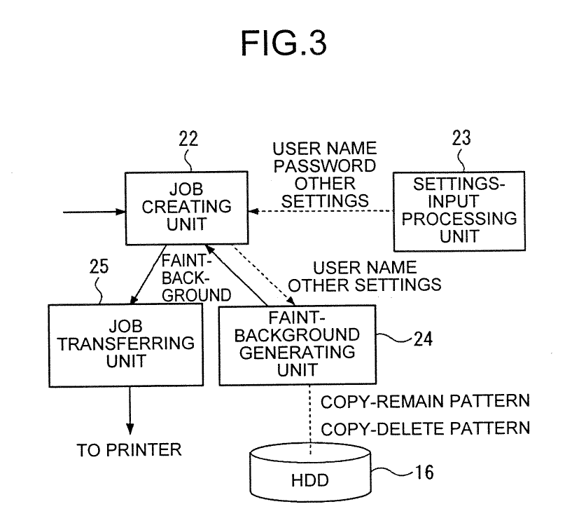

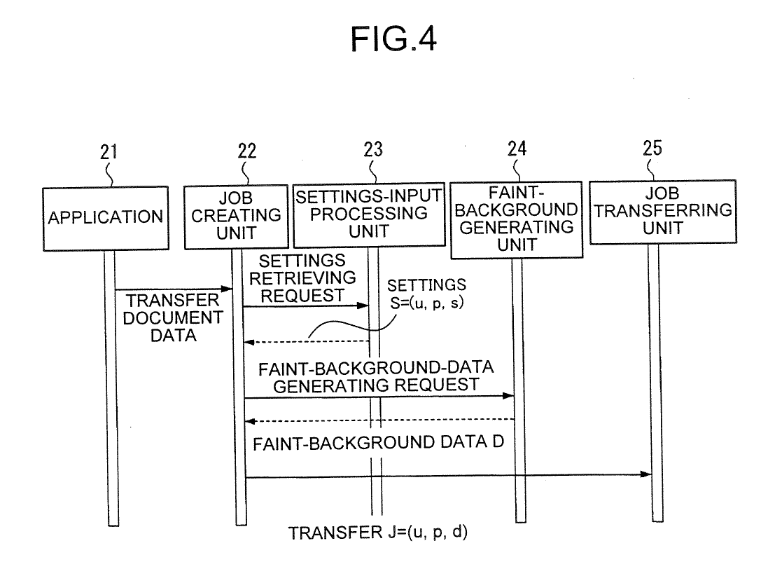

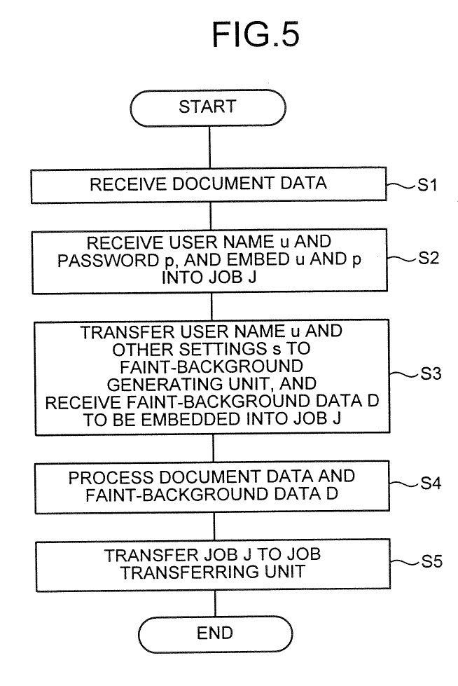

FIG. 3 is a block diagram for explaining a software structure of the computer terminal 10. An application 21 is not shown. The computer terminal 10 includes a plurality of controlling software corresponding to a job creating unit 22, a settings-input processing unit 23, a faint-background generating unit 24, a job transferring unit 25, and the HDD 16. Solid lines with arrows indicate job sequence and dashed lines with arrows indicate data flow. FIG. 4 is a sequence diagram for explaining a processing sequence of the controlling software shown in FIG. 3. FIG. 5 is a flowchart for explaining a process performed by the job creating unit 22 shown in FIG. 4.

The application 21 generates a print data (hereinafter, a document data) corresponding to a command input by the user from the inputting unit 17 on a screen of the displaying unit 15 and transfers the document data to the job creating unit 22. The document data is used as master data to print the original document.

The job creating unit 22 receives the document data from the application 21 and various settings from the settings-input processing unit 23. Then, by using the various settings, the job creating unit 22 processes the document data into a job data (printing job) that can be printed by a printer (hereinafter, printer 1).

Namely, when the document data is transferred from the application 21, the job creating unit 22 starts a processing sequence shown in FIG. 5 and receives the document data at step S1.

At step S2, the job creating unit 22 sends a settings retrieving request to the settings-input processing unit 23 and receives a user name u, a password p, and other settings (printing conditions) s from the settings-input processing unit 23.

If receiving the settings retrieving request from the job creating unit 22, the settings-input processing unit 23 accepts an input of the user name u, the password p, and the other settings s, which are set for the printing by the user from the inputting unit 17. If the settings S are input to the settings-input processing unit 23, the settings-input processing unit 23 transfers the settings S to the job creating unit 22. The settings S are necessary information to perform authentication in a printer to be used by the user.

At step S3, the job creating unit 22 sends a faint-background-data generating request together with the user name u and the other settings s to the faint-background generating unit 24 and receives a faint-background data D to embed the faint-background data D into a printing job J.

If receiving the faint-background-data generating request from the job creating unit 22, the faint-background generating unit 24 generates a pattern of a character string corresponding to the user name u by using a copy-remain pattern and a copy-delete pattern in the HDD 16. Then the generated pattern, including a copy-control pattern that appears on a copy, is embedded into the faint-background data D and the faint-background generating unit 24 transfers the faint-background data D to the job creating unit 22. It is assumed here that the user name u, which is included in the faint-background-data generating request and used for performing authentication, is rendered by the copy-remain pattern.

At step S4, the job creating unit 22 processes the document data received at step S1 and the faint-background data D generated at step S3 into a printing-allowed printing job d by referring to the other settings s and embeds the printing data d into the printing job J.

At step S5, the job creating unit 22 transfers the printing job J including the user name u, the password p, and the printing data d, to the job transferring unit 25.

If receiving the printing job J from the job creating unit 22, the job transferring unit 25 transfers the printing job J to any one of the printers 1 to 3 by using the I/O port 11.

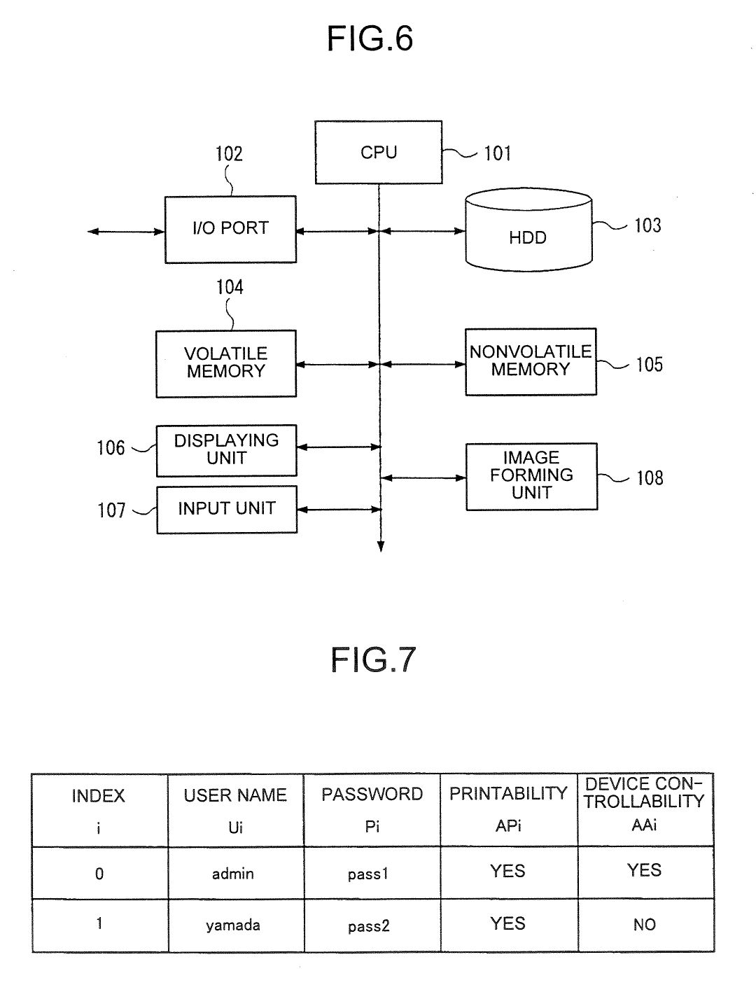

FIG. 6 is a block diagram for explaining a hardware structure of the printer 1. As the hardware structures of the printers 2 and 3 are the same as the printer 1, detail explanations of the printers 2 and 3 will be omitted. The printer 1 includes a CPU 101, an I/O port 102, an HDD 103, a volatile memory 104, a nonvolatile memory 105, a displaying unit 106, an inputting unit 107, and an image forming unit 108.

The CPU 101 centrally controls the printer 1. The I/O port 102 is a communication tool for receiving the printing job J from the computer terminals 10 and 20. The HDD 103 is a high capacity memory and stores therein various data including user information. The volatile memory 104 is a readable and writeable memory, such as a RAM, to be used as a work-area for various processing and used as an image-creating area for creating a bitmap image by using the printing job.

The nonvolatile memory 105 is a memory, such as a flash ROM, and stores the control program (control software) and various data including the copy-delete pattern and the copy-remain pattern.

The displaying unit 106 can be a cathode-lay tube (CRT) display or a liquid crystal display (LCD) and displays the status of the printer 1 or the user information. The inputting unit 107 is used by a user for inputting the user information or the like. The image forming unit 108 performs image forming processing to transcribe the bitmap image created by the CPU 101 onto a paper.

The CPU 101 selectively executes various programs in the nonvolatile memory 105 to realize various functions corresponding to an authentication processing unit and a job control unit.

FIG. 7 is a table of the user information in the HDD 103. The user information includes a plurality of predetermined indices i, user names Ui, passwords Pi, information of printability APi, and information of device controllability AAi. If the device controllability AAi belonging to a user is YES, the user can change the user information. Although the passwords are described in human-readable characters in FIG. 7, the passwords are generally encoded by using data encryption standard (DES) or other methods.

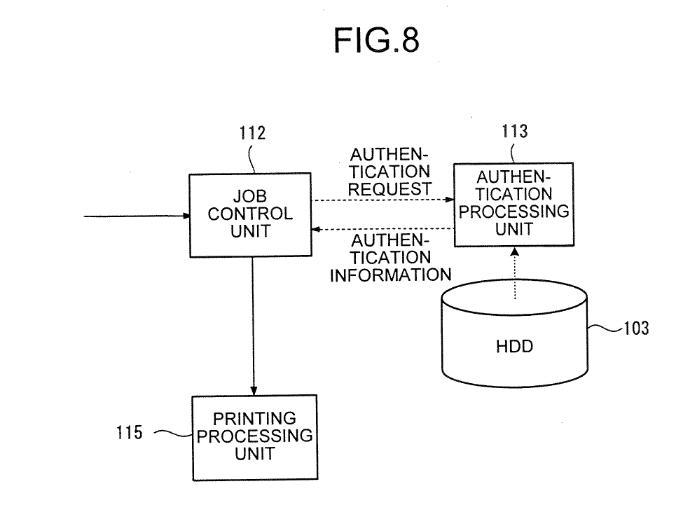

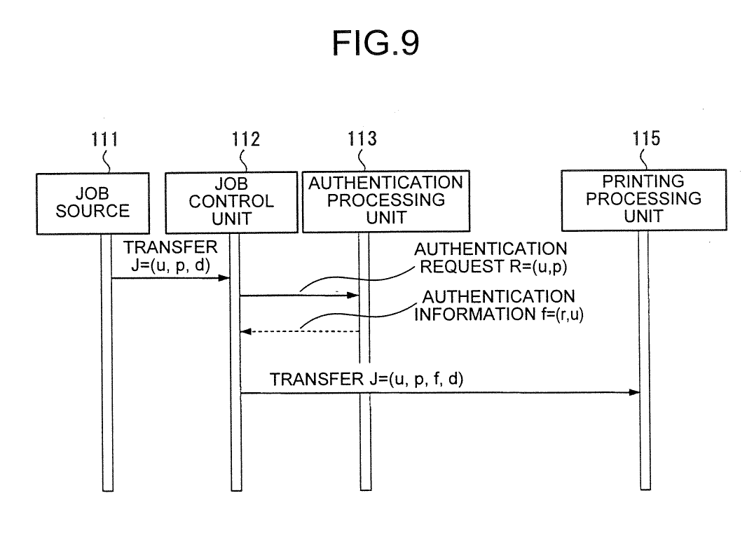

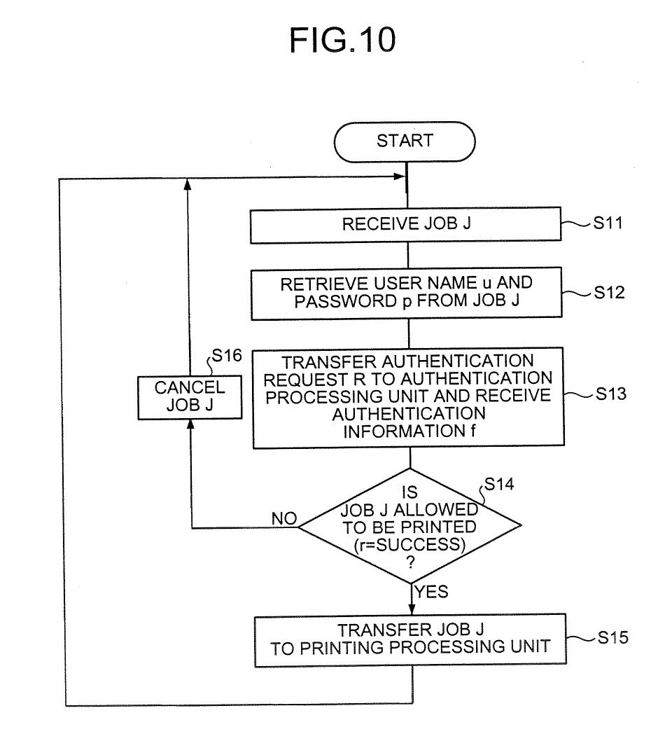

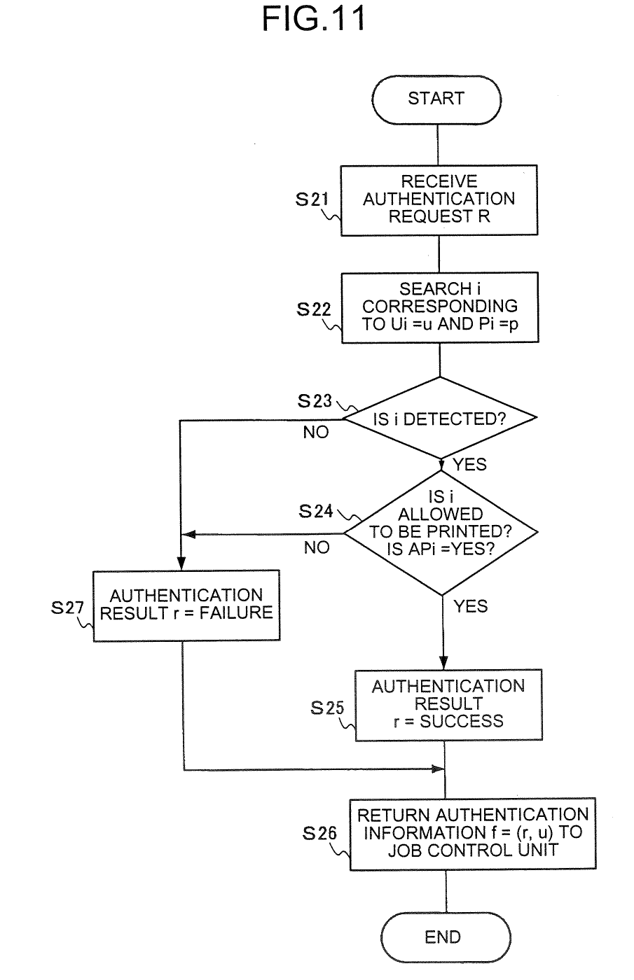

FIG. 8 is a block diagram for explaining a software structure of the printer 1. The printer 1 includes a plurality of controlling software corresponding to a job control unit 112, an authentication processing unit 113, and a printing processing unit 115. Solid lines with arrows indicate job sequence and dashed lines with arrows indicate data flow. FIG. 9 is a sequence diagram for explaining a processing sequence of the controlling software shown in FIG. 8. A job source 111 corresponds to the computer terminal 10 or 20. FIG. 10 is a flowchart for explaining a process performed by the job control unit 112. FIG. 11 is a flowchart for explaining a process performed by the authentication processing unit 113.

If the printing job J is transferred from the job source 111 (computer terminal 10 or 20), the job control unit 112 starts a processing sequence shown in FIG. 10 and receives the printing job J (user name u, password p, printing data d) from the job source 111 at step S1. At step S12, the job control unit 112 retrieves the user name u and the password p from the printing job J.

At step S13, the job control unit 112 sends an authentication request R including the user name u and the password p to the authentication processing unit 113 and receives authentication information f including authentication result r, which indicates authentication success or authentication failure, and the user name u from the authentication processing unit 113.

At step S14, the job control unit 112 verifies whether printing of the printing data d of the printing job J is allowed by referring to the authentication information f. If printing of the printing job d is determined to be allowed, the job control unit 112 embeds the authentication information f into the printing job J and transfers the printing job J to the printing processing unit 115 at step S15. If printing of the printing data d is determined not to be allowed, the job control unit 112 cancels the printing job J at step S16.

If the authentication request R including the user name u and the password p is transferred from the job control unit 112, the authentication processing unit 113 starts a processing sequence shown in FIG. 11 and receives the authentication request R at step S21. At step S22, the authentication processing unit 113 searches index i, which corresponds to a user name Ui and a password Pi. The user name Ui corresponds to the user name u and the password Pi corresponds to the password p as can be indicated as Ui=u and Pi=p.

At step S23, the authentication processing unit 113 verifies whether the index i is detected. If the index i corresponding to the user information is detected in the HDD 103, the authentication processing unit 113 verifies whether printing of the index i is allowed by referring to the corresponding printability information APi at step S24. If the printability information APi corresponding to the index i indicates that printing of the printing job is allowed, the authentication processing unit 113 sets the authentication result r as authentication success at step S25. If the index i corresponding to the user information is not detected in the HDD 103 or if the printability information APi corresponding to the index i indicates that printing of the printing job is not allowed, the authentication processing unit 113 sets the authentication result r as authentication failure at step S27. At step S26, the authentication processing unit 113 transfers the authentication information f including the authentication result r and the user name u, to the job control unit 112.

If the printing processing unit 115 receives the printing job J from the job control unit 112, the printing processing unit 115 begins a rendering of the printing job J to create the bitmap image, develops the bitmap image to the image-creating area in the volatile memory 104, and outputs the bitmap image to the image forming unit 108 to print the bitmap image on a paper.

According to the first embodiment, when the computer terminal (host apparatus) embeds the faint-background data including an copy-control pattern, which is generated from the copy-remain pattern and the copy-delete pattern, into the printing job (including the master data) and transfers the printing job to the printer, the computer terminal embeds a part of the predetermined information, which is used for performing authentication in the printer and rendered by the copy-remain pattern, into the printing job. When the printer receives the printing job from the computer terminal before performing the printing, it verifies whether printing of the printing job is allowed. If printing of the printing job is determined to be allowed, the printer prints the printing job (printing data) on a paper, so that when the paper is copied, the copy-remain pattern becomes visible on a copy. As a result, it becomes obvious that the printed material is a copy and not the original, and as the visualized copy-remain pattern includes the information input by the user, it becomes possible to identify the user who output the original.

Furthermore, according to the first embodiment, the printer determines that printing of the printing job is allowed and performs the printing only when any received information corresponds to the predetermined information, such as the user name and the password. Therefore, it becomes possible to enhance the security.

Moreover, according to the first embodiment, when the computer terminal embeds the faint-background data into the printing job and transfers the printing job to the printer, any patterns rendered by the copy-remain pattern can be embedded and the input information rendered by the copy-delete pattern can also be embedded into the printing job. As the copy-remain pattern and the copy-delete pattern are combined and to be printed on a paper, the input information becomes visible on a copy when the paper is copied.

In a second embodiment of the present invention, hardware structures of the printing system, the computer terminal 10 and 20, and the printers 1 to 3 are the same as the first embodiment as shown in FIGS. 1, 2, and 6. It is unique in the second embodiment that the CPU 101 in the printers 1 to 3 executes processing by using a control program in the nonvolatile memory 105 to realize functions corresponding to a faint-background generating unit 114.

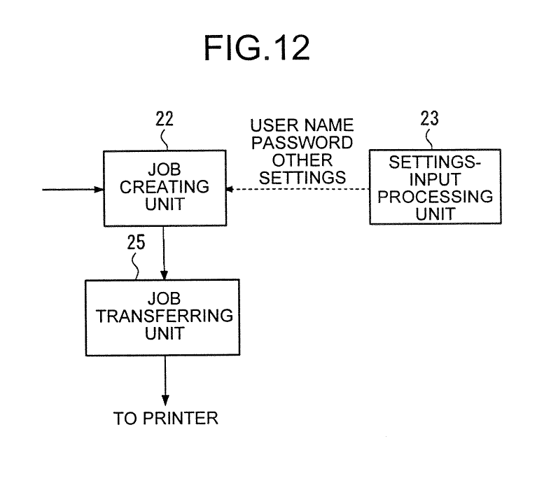

FIG. 12 is a block diagram for explaining another software structure of the computer terminal 10. The computer terminal 10 includes a plurality of controlling software corresponding to the job creating unit 22, the settings-input processing unit 23, and the job transferring unit 25. The application 21 is not shown. Solid lines with arrows indicate job sequence and dashed lines with arrows indicate data flow.

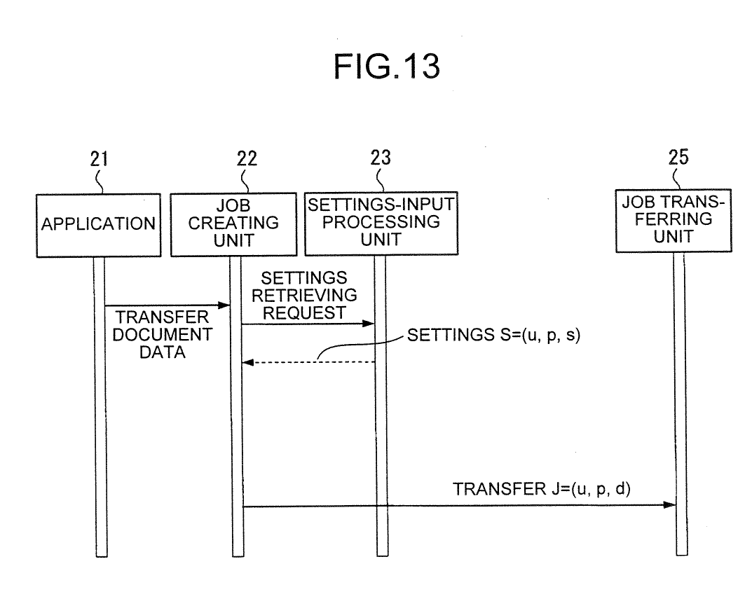

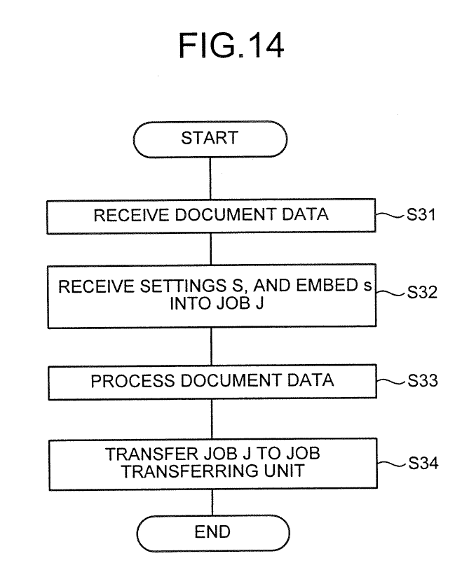

FIG. 13 is a sequence diagram for explaining a processing sequence of the controlling software shown in FIG. 12. FIG. 14 is a flowchart for explaining a process performed by the job creating unit 22 shown in FIG. 13.

The application 21 generates a print data (hereinafter, a document data) corresponding to a command input from the inputting unit 17 on the displaying unit 15 and transfers the document data to the job creating unit 22. The document data is used as master data to print the original document.

The job creating unit 22 receives the document data from the application 21 and various settings from the settings-input processing unit 23. Then, by using the various settings, the job creating unit 22 processes the document data into a printing job (printing data) that can be printed by a printer (hereinafter, printer 1).

Namely, when the document data is transferred from the application 21, the job creating unit 22 starts a processing sequence shown in FIG. 14 and receives the document data at step S31.

At step S32, the job creating unit 22 sends the settings retrieving request to the settings-input processing unit 23 and receives a settings S from the settings-input processing unit 23 and embeds the user name u and the password p to the printing job J.

If receiving the settings retrieving request from the job creating unit 22, the settings-input processing unit 23 accepts an input of the user name u, the password p, and the other settings s from the user by using the inputting unit 17. If the settings S are input to the settings-input processing unit 23, the settings-input processing unit 23 transfers the settings S to the job creating unit 22. The settings S are necessary information to perform authentication in a printer to be used by the user.

At step S33, the job creating unit 22 processes the document data received at step S31 into a printing-allowed printing data d by referring to the other settings s and embeds the printing data d to the printing job J.

At step S34, the job creating unit 22 transfers the printing job J including the user name u, the password p, and the printing data d, to the job transferring unit 25.

If receiving the printing job J from the job creating unit 22, the job transferring unit 25 transfers the printing job J to the printer 1 by using the I/O port 11.

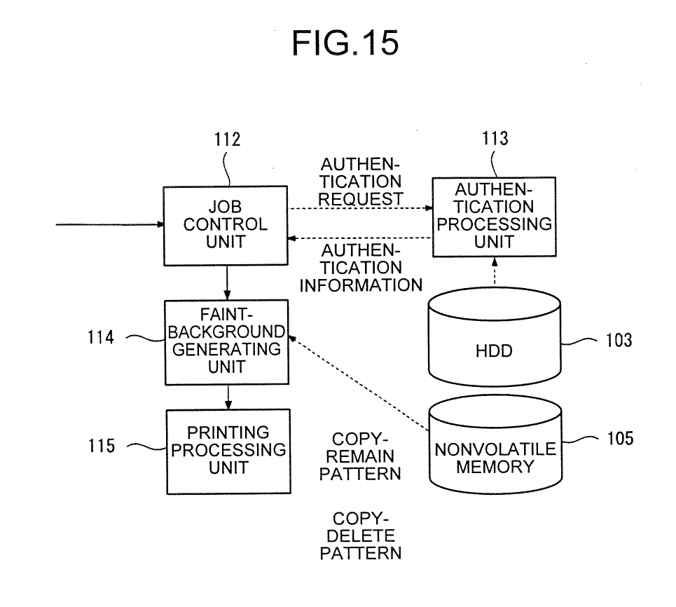

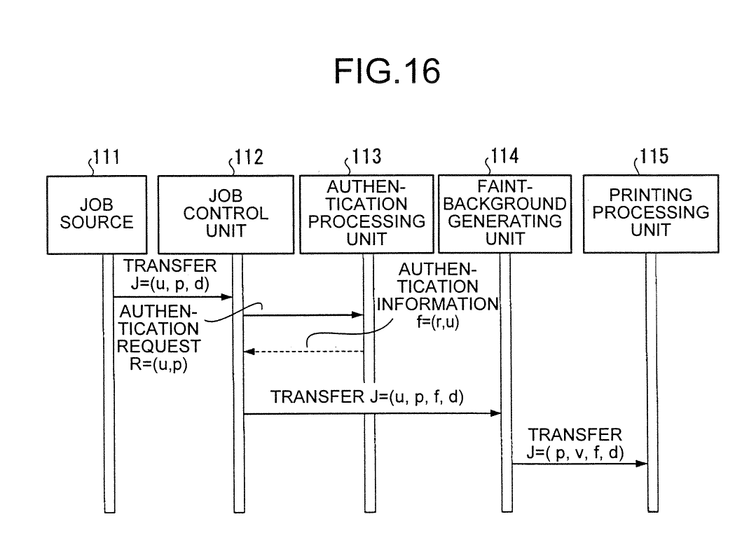

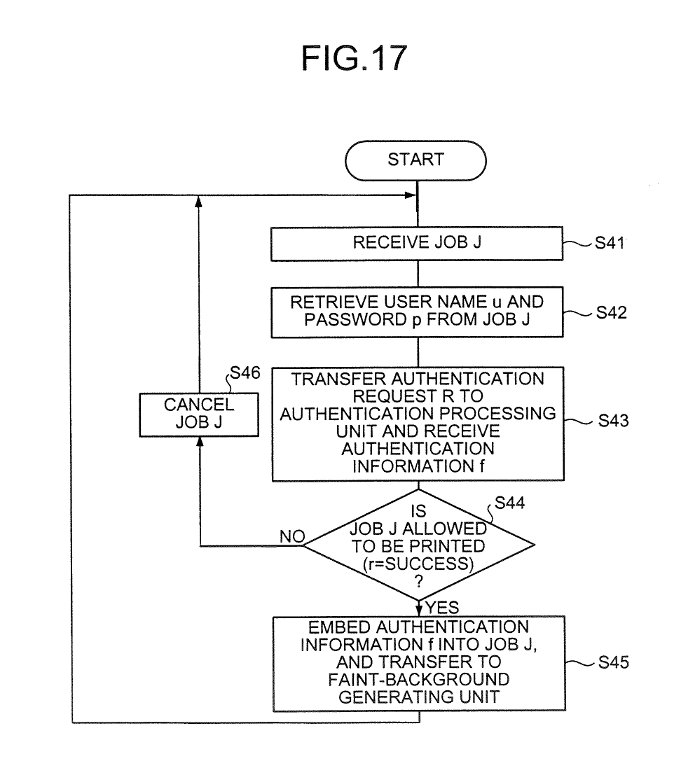

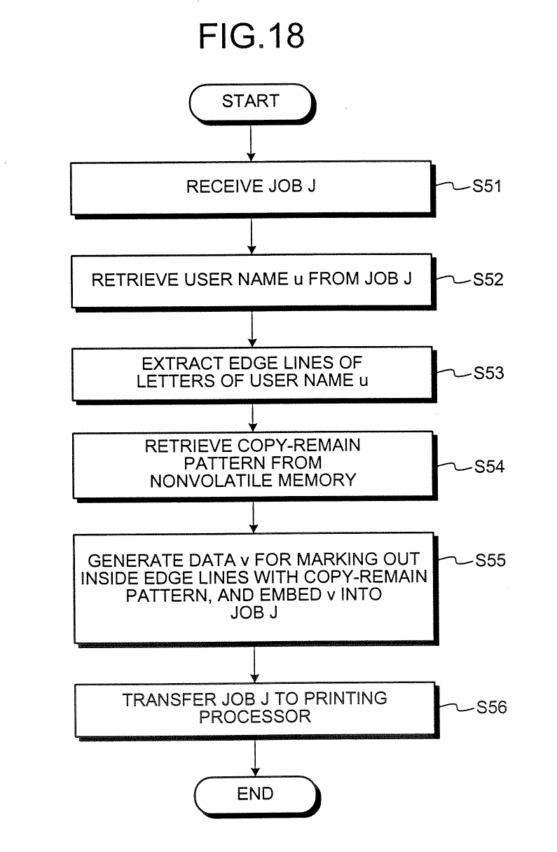

FIG. 15 is a block diagram for explaining another software structure of the printer 1. The printer 1 includes a plurality of controlling software corresponding to the job control unit 112, the authentication processing unit 113, the faint background generation unit 114, the printing processing unit 115, the HDD 103, and the nonvolatile memory 105. Solid lines with arrows indicate job sequence and dashed lines with arrows indicate data flow. FIG. 16 is a sequence diagram for explaining a processing sequence of the controlling software shown in FIG. 15. The job source 111 corresponds to the computer terminal 10 or 20. FIG. 17 is a flowchart for explaining a process performed by the job control unit 112. FIG. 18 is a flowchart for explaining a process performed by the faint-background generating unit 114.

If the printing job J is transferred from the job source 111, the job control unit 112 starts a processing sequence shown in FIG. 17 and receives the printing job J (user name u, password p, and printing data d) from the job source 111 at step S41. At step S42, the job control unit 112 retrieves the user name u and the password p from the printing job J.

At step S43, the job control unit 112 sends an authentication request R including the user name u and the password p to the authentication processing unit 113 and receives authentication information f including authentication result r, which indicates authentication success or authentication failure, and the user name u from the authenticating processing unit 113.

At step S44, the job control unit 112 verifies whether printing of the printing data d of the printing job J is allowed by referring to the authentication information f. If printing of the printing data d is determined to be allowed, the job control unit 112 embeds the authentication information f into the printing job J and transfers the printing job J to the faint-background generating unit 114 at step S45. If printing of the printing data d is determined not to be allowed, the job control unit 112 cancels the printing job J at step S46.

If the authentication request R including the user name u and the password p is transferred from the job control unit 112, the authentication processing unit 113 starts the processing sequence shown in FIG. 11.

If receiving the printing job J including the user name u, the password p, the authentication information f, and the printing data d from the job control unit 112, the faint-background generating unit 114 starts a processing sequence shown in FIG. 18 and receives the printing job J at step S51. At step S52, the faint-background generating unit 114 retrieves the user name u from the printing job J. At step S53, the faint-background generating unit 114 extracts border lines of letters of the user name u.

At step S54, the faint-background generating unit 114 retrieves the copy-remain pattern from the nonvolatile memory 105. At step S55, the faint-background generating unit 114 generates data v to be used for marking out the letters of the user name u framed by the border lines with the retrieved copy-remain pattern and embeds the data v into the printing job J. At step S56, the faint-background generating unit 114 transfers the printing job J to the printing processing unit 115.

If receiving the printing job J from the faint-background generating unit 114, the printing processing unit 115 begins a rendering of the printing job J to create the bitmap image, develops the bitmap image to the image-creating area in the volatile memory 104, outputs the bitmap image to the image forming unit 108 to print the bitmap image on a paper, and marks out the letters of the user name u framed by the border lines with the copy-remain pattern.

According to the second embodiment, when the printer embeds the faint-background data including a copy-control pattern, which is generated from the copy-remain pattern and the copy-delete pattern, into the printing job and performs the printing, the printer verifies whether printing of the printing job is allowed. If printing of the printing job is determined to be allowed and when the printer prints the printing job (printing data) on a paper, the printer embeds the copy-remain pattern including the authentication information, such as the user name, into the printing job so that the authentication information becomes visible on a copy when the paper is copied. As a result, it becomes obvious that the paper is not the original and it becomes possible to identify the user who output the original.

Furthermore, according to the second embodiment, the printer verifies that printing of the printing job is determined to be allowed when any received information matches with the predetermined information, such as the user name and the password, and uses the user name to perform authentication. Therefore, it becomes possible to enhance the security.

Moreover, according to the second embodiment, when the printer prints the printing job, any patterns rendered by the copy-remain pattern can be embedded and the input information rendered by the copy-delete pattern can also be embedded into the printing job. As the copy-remain pattern and the copy-delete pattern are combined and to be printed on a paper, the input information becomes visible on a copy when the paper is copied.

The present invention is not limited to the above explained embodiments and can be applied to various image forming apparatuses such as a printer that can print the faint-background data, a digital copying machine, or a facsimile apparatus, and various printing systems including the image forming apparatuses and the computer terminals.

A computer program according to an embodiment of the present invention is a program that enables the CPU to perform various functions, for example, corresponding to the authentication processing unit, the job control unit, the faint-background generating unit to realize the above explained effects.

The computer program can be pre-stored in a ROM or a HDD, or alternately, can be stored in the nonvolatile memory such as a CD-ROM, a flexible disk (FD), a static random access memory (SRAM), an electronically erasable and programmable read only memory (EEPROM), or a memory. The pre-stored computer program can be executed by the computer terminal, or alternately, the computer program stored in the nonvolatile memory can be extracted by the computer terminal to execute the computer program, perform the processing, and realize the functions explained above.

Further, the computer program can be downloaded from an external device that includes a recording medium storing the computer program therein or an external device having the computer program therein via a network.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A printing system comprising:
an information processing apparatus that processes various types of data; and
a printing apparatus connected to the information processing apparatus via a network, wherein
the information processing apparatus includes
an input processing unit that receives information required to obtain an authentication from the printing apparatus;
a faint-background generating unit that appends a part of the received information to a printing job as faint-background data including a copy-control pattern that appears on a copy of a document; and
a job transferring unit that transfers the printing job to the printing apparatus,
the printing apparatus includes
a job control unit that receives the printing job including the faint-background data from the information processing apparatus;
an authentication processing unit that performs an authentication process of determining whether printing of the received printing job is allowed, and
the job control unit executes the printing of the received printing job when an authentication is obtained with the authentication processing unit determining that the printing of the printing job is allowed.

2. The printing system according to claim 1, wherein
the faint-background data is copy-remain pattern that is optically readable at a time of copying the document.

3. The printing system according to claim 1, wherein
the faint-background data is copy-delete pattern that is optically unreadable at a time of copying the document.

4. The printing system according to claim 1, wherein
the authentication processing unit determines that the printing of the printing job is allowed when the received information is identical with pre-registered information.

5. The printing system according to claim 4, wherein
the pre-registered information includes a user name and a password.

6. A printing system comprising:
an authentication processing unit that performs an authentication process of determining whether printing of a printing job is allowed;
a job control unit that executes the printing of the printing job when an authentication is obtained with the authentication processing unit determining that the printing of the printing job is allowed; and
a faint-background generating unit that appends, upon the job control unit executing the printing of the printing job, information on the authentication to the printing job as faint-background data including a copy-control pattern that appears on a copy of a document.

7. The printing system according to claim 6, wherein
the faint-background data is copy-remain pattern that is optically readable at a time of copying the document.

8. The printing system according to claim 6, wherein
the faint-background data is copy-delete pattern that is optically unreadable at a time of copying the document.

9. The printing system according to claim 6, wherein
the authentication processing unit determines that the printing of the printing job is allowed when information identical with pre-registered information is input, and
the faint-background generating unit uses information with which the authentication is obtained with the authentication processing unit determining that the printing of the printing job is allowed, as the information on the authentication.

10. The printing system according to claim 9, wherein
the pre-registered information includes a user name and a password, and
the faint-background generating unit uses a user name with which the authentication is obtained with the authentication processing unit determining that the printing of the printing job is allowed, as the information on the authentication.

11. A computer-readable recording medium that stores a computer for performing a printing process, wherein
the computer program causes a computer to execute:
performing an authentication process of determining whether printing of a printing job is allowed;
executing the printing of the printing job when an authentication is obtained with the printing of the printing job determined to be allowed; and
appending, when the printing of the printing job is executed, information on the authentication to the printing job as faint-background data including a copy-control pattern that appears on a copy of a document.

12. The computer-readable recording medium to claim 11, wherein
the faint-background data is copy-remain pattern that is optically readable at a time of copying the document.

13. The computer-readable recording medium according to claim 11, wherein
the faint-background data is copy-delete pattern that is optically unreadable at a time of copying the document.

14. The computer-readable recording medium according to claim 11, wherein
the performing includes determining that the printing of the printing job is allowed when information identical with pre-registered information is input, and
the appending includes using information with which the authentication is obtained with the printing of the printing job determined to be allowed, as the information on the authentication.

15. The computer-readable recording medium according to claim 14, wherein
the pre-registered information includes a user name and a password, and
the appending includes using a user name with which the authentication is obtained with the printing of the printing job determined to be allowed, as the information on the authentication.
